(19) United States
(12) Patent Application Publication
(10) Pub. No.: US 2002/0124697 A1
(43) Pub. Date: Sep. 12, 2002

(54) Sheet processing machine

(75) Inventor: Johannes Georg Schaede, Wurzburg (DE)

Correspondence Address: JONES, TULLAR & COOPER, P.C., Eads Station, P.O. Box 2266, Arlington, VA, 22202, US

(73) Assignee: KOENIG & BAUER AKTIENGESELLSCHAFT, Wurzburg (DE)

(21) Appl. No.: 09/865,427

(22) Filed: May 29, 2001

Related U.S. Application Data
(62) Division of application No. 09/284,471, filed on Apr. 20, 1999, now Pat. No. 6,260,456.

(30) Foreign Application Priority Data
Oct. 21, 1996 (DE) 196 43 409.2
Dec. 21, 1996 (DE) 196 53 927.7

(51) Int. Cl. B26F 1/18

(52) U.S. Cl. 83/34; 83/156

(57) ABSTRACT

A sheet processing machine receives sheets from a sheet feeder. The sheets are inspected and their trailing ends are trimmed. Subsequently, the sheets are turned and are split into a plurality of partial sheets or sheet pieces. The now trailing ends of the sheet pieces are trimmed. The sheet pieces are separated axially and are delivered to a sheet receiving device where the individual sheet pieces are deposited in various stacks.

The invention relates to a method for cutting sheets and to a sheet processing machine in accordance with the preambles of claims 1 and 11.

DE-AS 10 44 589 describes a transverse cutting device for paper webs. A belt system for transporting the sheets cut from the web is connected downstream of the transverse cutting device.

DE 43 13 452 A1 describes a device for cutting of sheets from a web. Two transverse cutting mechanisms are provided with this device, by means of which first a leading end of the web is exactly cut to measure and the sheet is then cut off the web.

DE 42 38 387 A1 discloses a cut registration regulating device on transverse cutters of rotary printing presses. Here, a rotating cylinder is provided, which works together with a stationary opposed cutter.

The object of the invention is based on creating a method for cutting sheets, and on a sheet processing machine with a cutting device.

In accordance with the invention, this object is attained by means of the features of the characterizing portions of claims 1 and 11.

The advantages which can be achieved by means of the invention lie in particular in that transverse cutting from the start to the end of a sheet takes place without manual intervention in a sheet processing machine. It is possible by means of integrated inspection devices to control the print quality itself, as well as the cut registrations in the sheet processing machine. In this way it is possible to simultaneously control the fronts and backs of the sheet, which were printed, for example, on the obverse and reverse sides of the sheet.

A simple cut registration adjustment is possible because of the working together of the transverse cutting devices with a chain conveyor, which is advantageously performed by means of a position-controlled electric motor driving a cutting cylinder.

A longitudinal cutting device is assigned to a processing cylinder of the sheet processing machine, so that the sheet is cut “in-line” into two or more partial sheets. These sheets can be deposited on stacks, which can be selected by means of the inspection device, for example, i.e. sorted stacks with “good” and with waste sheets are formed. This has the advantage that in case of a defective partial sheet the entire sheet is not wasted.

By means of this sheet processing machine all sides of a sheet are cut and the latter is cut into partial sheets. All cuts made, as well as the obverse and reverse printing, are controlled by means of inspection devices, and are deposited on selectable stacks.

This sheet processing machine performs a plurality of processing steps “in-line”, which leads to an increase in production and a reduction of manual labor. Moreover, the quality of the products made in this way is increased.

The sheet processing machine in accordance with the invention is represented in the drawings and will be described in greater detail in what follows.

Shown are in:

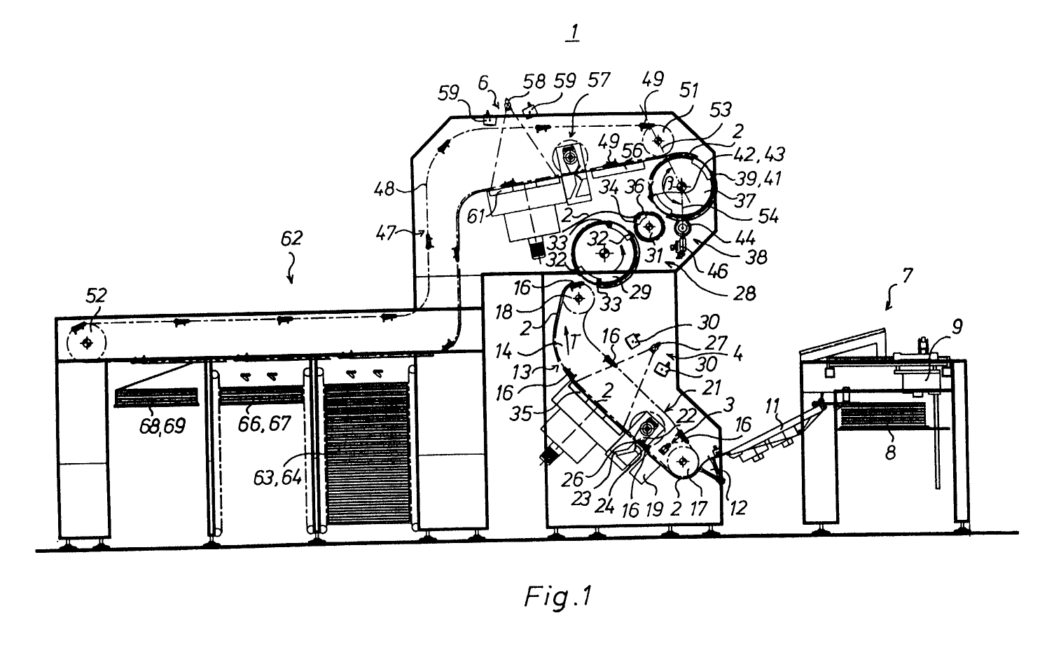

FIG. 1, a schematic lateral view of a sheet processing machine;

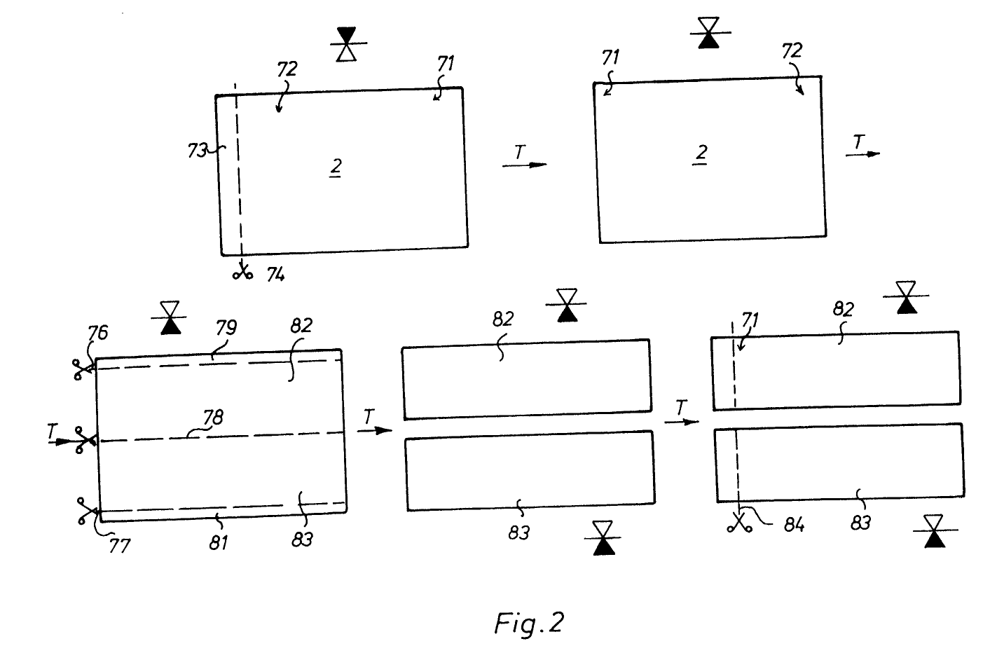

FIG. 2, a schematic representation of the processing steps in the sheet processing machine;

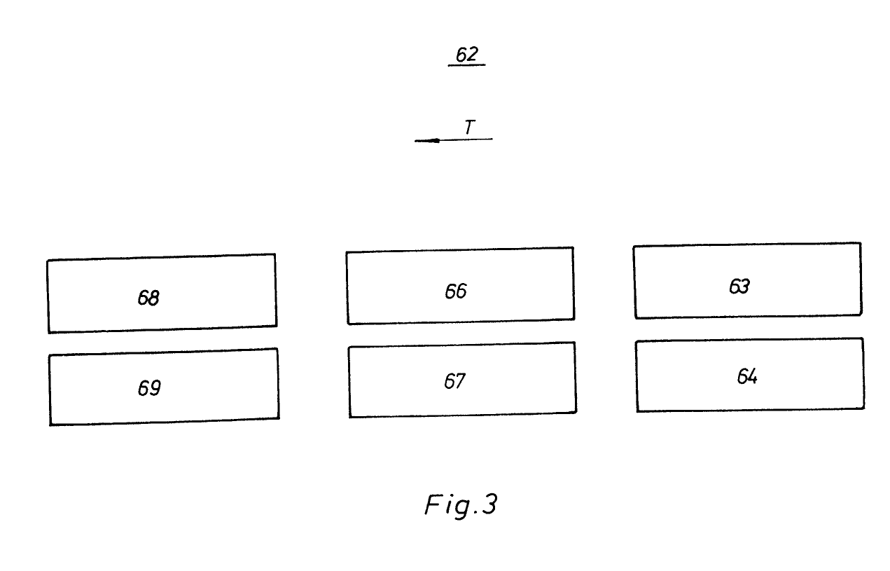

FIG. 3, a schematic view from above on a stack of a delivery device of the sheet processing machine;

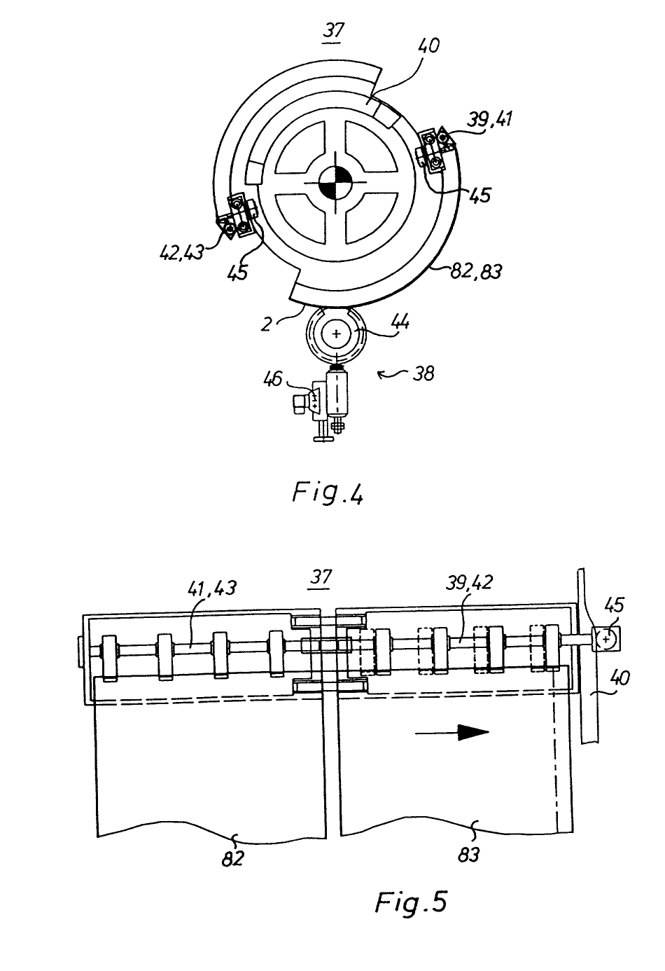

FIG. 4, an enlarged schematic lateral view of a processing cylinder of the sheet processing machine in accordance with FIG. 1;

FIG. 5, an enlarged schematic view from above on the processing cylinder of the sheet processing machine in accordance with FIG. 1 and FIG. 5.

A sheet processing machine 1 for the transverse and longitudinal cutting of sheets 2 has integrated inspection devices 3, 4, 6. The sheets preferably are printed paper sheets, for example securities. For instance, this sheet processing machine 1 is constructed as follows:

A feeder 7 essentially has a first stack 8, a sheet separating device 9 and a delivery table 11. This feeder 7 is followed by an installation 12 which is designed as a swing feeder. A first chain conveyor 13 works together with this swing installation 12. This chain conveyor 13 has a pair of revolving chains 14, to which axially extending chain gripper systems 16 have been attached. The chains 14 are reversed by a first, 17, and a second chain wheel shaft 18. The chains 18 extend at least partially along a straight line between the first, 17, and second chain wheel shaft 18. Viewed in the transport direction T, the first inspection device 3 is arranged downstream of the first chain wheel shaft 17. This inspection device 3 has a suction box 19, whose work surface facing the chain gripper system 16 is made at least partially transparent. Illumination installations, not represented, are arranged under this transparent work surface.

A first transverse cutting device 21 is connected downstream of this suction box 19. The transverse cutting device 21 has a rotating cutting cylinder 22 and a stationary opposed cutter 24 fastened on a cross bar 23. The cutting cylinder 22 is provided with at least one axially extending groove, into which a passing chain gripper system 16 can descend. A width of the groove in the circumferential direction is made larger than a width required by the chain conveyor 16, so that passing chain gripper systems 16 and cutting cylinders 22 can be phase-shifted in respect to each other for adjusting the cut registration. In the present example, rotating arms are provided on both sides, between which an axially extending cross bar is arranged to receive a cutter 26.

The cutting cylinder 22 has a drive, whose phase can be changed in respect to the chain conveyor 13 and which, in the present example, is advantageously embodied as a separate, position-controlled electric motor.

The opposed cutter 24 is arranged in a slightly oblique way in respect to the axis of rotation of the cutting cylinder 22, i.e. the opposed cutter forms an opening angle alpha with the transport direction T, which is not equal to 90°, for example 89°. From this, an angle of inclination of the opposed cutter 24 of, for example, 1° in respect to the axis of rotation of the cutting cylinder 22 results. The opposed cutter 24 is slightly rotated around its longitudinal axis, i.e. the opposed cutter 24 has a slight twist.

The electric drive mechanism of the cutting cylinder 22 follows the chain conveyor 13 at an identical circumferential speed, so that because of the twist and the superimposed conveying speed, an exactly right-angled cut of the sheet 2 is created in the end.

The axially extending cutter 26 of the cutting cylinder 22 is slightly inclined in respect to the axis of rotation of the cutting cylinder 22 and has a twist in the longitudinal direction. The cutter 26 of the cutting cylinder 22 and the opposed cutter 24 are matched to each other.

A rotating opposed cylinder which, for example, has an opposed cutter 24 for performing a scissors cut, or an opposed strip, is also possible in place of the stationary opposed cutter 24. It is also possible to design the cutter 26 and the opposed cutter 24 parallel in relation to the axis of rotation of the cutting cylinder 22 and without a twist. The cutting cylinder 22, or respectively the opposed cylinder, can also have several cutters 26.

A second inspection device 4 is installed downstream of this transverse cutting device 21 in the area of the chain conveyor 13. This second inspection device 4 essentially consists of a sensor 27, illumination devices 30 and a suction box 35.

A turning device 28 follows the chain conveyor 13. In the present example, this turning device 28 essentially consists of a storage drum 29 and a turning drum 31. The storage drum 29 has a “double” circumference and is therefore equipped with two controllable gripper systems 32, which are arranged offset by 180° in respect to each other, and two oppositely located suction systems 33. A distance in the circumferential direction between the gripper systems 32 and the suction systems 33 can be adjusted to the length of the sheets to be conveyed. The suction systems 33 are movable in the circumferential direction and in the axial direction.

The turning drum 31 has two controllable gripper systems 34, 36, which are placed side-by-side and are pivotably arranged around their longitudinal axis.

The turning drum 31 and the storage drum 29 can be phase-shifted in respect to each other.

A cylinder 37, for example a processing cylinder 37, with a cooperating longitudinal cutting device 38, is connected downstream of the turning device 28. This processing cylinder 37 has, for example, at least twice the circumference, and four holding systems 39, 41, 42, 43, which are designed as gripper systems 39, 41, 42, 43 and are controllable independently of each other. These holding systems 39, 41, 42, 43 can also be embodied as suction devices. Two of these gripper systems 39, 41, or respectively 42, 43 are respectively located in a cylinder groove approximately axis-symmetrical next to each other in the axial direction in relation to a center of the processing cylinder 37, and are displaceable in relation to each other in the axial direction. In the present example, one of the gripper systems 39, or respectively 42, located axially next to each other, is arranged fixed in the axial direction, and the second gripper system 41, or respectively 43, is displaceable in relation to the first gripper system 39, or respectively 42, for example by means of a cam 40 and cam rollers 45. However, both gripper systems 39, 41, or respectively 42, 43, can be displaceable. A second pair of these gripper systems 42, 43 is located opposite a first pair of two gripper systems 39, 41 designed in this way and is offset by 180°.

The longitudinal cutting device 38 with a plurality of cutter wheels 44, which is assigned to the processing cylinder 37, is placed downstream in the sheet transport direction T shortly after the turning drum 31. In the present example, the longitudinal cutting device 38 has an axially extending cross bar 46, on which three cutter wheels are arranged, which can be independently actuated and axially displaced.

A second chain conveyor 47 with two rotating chains 48 is arranged after the processing cylinder 37. A plurality of chain gripper systems 49 is arranged on these chains 48. These chain gripper systems 49 consist of two chain gripper systems, which are placed next to each other in the axial direction, are approximately symmetrically arranged in relation to the machine center and can be operated independently of each other. In place of the processing cylinder 37, the chain conveyor 47 can also have chain gripper systems which can be moved in relation to each other in the axial direction.

It is also possible that more than two gripper systems 39, 41, or respectively 42, 43, i.e. any arbitrary number, are displaceable. In case of three gripper systems, which are arranged axially next to each other, the gripper system arranged in the center, for example, could be fixed in place in the axial direction, and the two outer gripper systems could be designed so that they can be pushed away from the center system.

The chains 48 are reversed by a first and second chain wheel shaft 51, 52, A median line, constituted by the chain wheel shaft 51 and the processing cylinder 37, forms an opening angle beta of less than 180°, for example 155°, with a median line constituted by the processing cylinder 36 and the cutter wheels 44.

Downstream of this chain wheel shaft 51, a suction box 56 is arranged in the chain conveyor 47 underneath the chain 48. A second transverse cutting device 57 follows this suction box 56, which is constructed identical with the first transverse cutting device 21. The transverse cutting devices 21, 57 are used for trimming the ends 71, 72 of the sheets 2, 82, 83. The third inspection device 6 with a sensor 58, illumination devices 59 and a suction box 61, is connected downstream of this second transverse cutting device 57.

A feeder 62 in the area of the chain conveyor 47 follows. This feeder 62 has six stacks 63, 64, 66 to 69, respectively two of which are arranged in pairs next to each other, and the resulting three pairs of stacks 63, 64, or respectively 66, 67, or respectively 68, 69, are arranged behind each other. The stacks 63, 64, or respectively 66, 67, of the first two pairs of stacks respectively have common lifting devices, so that respectively one pair of stacks can be raised and lowered together. Separate lifting devices have been provided for the two stacks 67, 68 located next to each other, so that the two stacks 67, 68 can be raised and lowered independently.

Gripper systems, or respectively chain gripper systems are understood to be a plurality of grippers, which are arranged on a shaft which can be pivoted around a longitudinal axis.

The functioning of the sheet processing machine 1 is as follows:

A sheet 2, in particular a sheet of paper printed on the obverse and reverse sides, is fed from a first stack 8 to the delivery table 11 by means of the sheet separating device 9. The sheet 2 is grasped from this delivery table 11 by the swing installation 12 and is passed over to a chain gripper system 16 in the area of the first chain wheel shaft 17 of the first chain conveyor 13. The chain gripper system 16 conveys the sheet 2 along the “straight” portion of the chain conveyor 13 to the first inspection device 3. The sheet 2 is checked in segments for damage, for example tears and holes, by means of the first inspection device 3. The water mark of the sheet 2 is also inspected by means of back lighting. In the course of this the sheet 2 is guided by the suction box 19, to which a vacuum has been applied, of the first inspection device 3.

The chain gripper system 16 conveys the sheet 2 through the transverse cutting device 21 to the second inspection device 4. There, the sheet 2 is aspirated by the suction box 35 of the second inspection device 4 in the area of the front of the sheet 2. An end 72 of the sheet 2 is still in the transverse cutting device 21, in which a narrow strip 73, which extends in the axial direction, is cut off its end 73. In this case the conveying speed of the chain conveyor 13 and the circumferential speed of the cutter 26 are matched to each other, so that the end 72 of the sheet 2 is trimmed at right angles in respect to the transport direction T.

This sheet 2 having a first cut 74 is now inspected in the second inspection device 4. In the process a front side (obverse side) of the sheet 2 and a fresh edge of the sheet 2 (cut registration) resulting from the trimmed end 72 are inspected.

Thereafter, the chain gripper system 16 passes the front 71 of this sheet 2 on to a gripper system of the storage drum. This storage drum 29 conveys the sheet 2 in the direction toward the turning drum 31. When the end 72 of this sheet now reaches the area of the suction systems 33 of the storage drum, the latter aspirate the trimmed end 72. Subsequently the suction systems 33 move in an approximate arrow shape away from the center of the storage drum 29 and in this way tense the sheet 2 in the circumferential direction as well as in the direction toward lateral edges of the sheet 2.

The phase shift between the turning drum 31 and the storage drum 29 is set to the length of the sheets 2 to be processed. The storage drum 29 conveys the front 71 of the sheet 2 through the gap between the turning, 31, and storage drums 29 until the suction systems 33 reach this gap. The trimmed end 72 of the sheet 2 is grasped by the first gripper system 34 of the turning drum 31 and is released from the suction system 33 by turning off the vacuum. Thereafter both gripper systems 34, 36 of the turning drum 31 are pivoted against each other, and the trimmed end 72 is passed from the first gripper system 34 to the second gripper system 36. In their continued course the gripper systems 34, 36 pivot back into their initial position.

The trimmed end 72 is now grasped by the gripper system 36 so that it leads, and the untrimmed front 71 trails.

The sheet 2 is passed on by the turning drum 31 to a pair of gripper systems 39, 41, or respectively 42, 43 of the processing cylinder 37. On the processing cylinder 37, the sheet 2 is provided with three cuts 76, 77, 78 in the longitudinal direction—i.e. in the transport direction T—. Narrow strips 79, 81 are cut off the two longitudinal sides of the sheet 2 by the second and third cut 76, 77.

The gripper division of the gripper systems 39, 41, 42, 43 of the processing cylinder 37, and the width, as well as the position, of the sheet 2, are matched to each other in such a way that the two cut-off strips 79, 81 are not grasped by the grippers.

The fourth cut 78 separates the sheet 2 in the center into two partial sheets 82, 83. Here, too, there is no gripper in the area of the cut 78.

When these three longitudinal cuts 76, 77, 78 are completely performed, also at the maximum length of the sheet 2, the two partial sheets 82, 83 are moved apart in the axial direction. To this end, in the present example a gripper system 41, or respectively 43, or 39, or respectively 42, performs a lifting motion in the axial direction by means of a cam roller working together with a cam disk. Only after these two partial sheets 82, 83 have been moved away from each other are these two partial sheets 82, 83 passed on to a chain gripper system 49 of the second chain conveyor 47 in the area of the first chain wheel shaft 51. The gripper system 41, or respectively 43, of the processing cylinder 37 is moved back into its initial position before the next sheet 2 is taken over.

The spaced-apart partial sheets 82, 83 are conveyed on in a common conveying direction, or respectively plane.

The two partial sheets 82, 83 are conducted to the second transverse cutting device 57 by this chain gripper system 49. To steady the sheet 2, it is aspirated along the suction box 56 which is connected upstream of the transverse cutting device 57, and the end 72 of the partial sheets 82, 83 in the chain gripper system 49 is already passed over the suction box 61 of the third inspection device 6. From the front 71 of the sheet 2, i.e. of the two pulled-apart partial sheets 82, 83, which now trails, a strip 86 is axially cut off at right angles in respect to the transport direction T by means of a fifth cut 84. The sheet 2 has now been trimmed on all sides and separated into two partial sheets 82, 83.

A back (reverse side) of the sheet 2, i.e. the backs of the two partial sheets 82, 83, together with the edges trimmed in the longitudinal direction, and the trailing front 71 of the sheets 2, i.e. the trailing ends of the partial sheets 82, 83 trimmed in the axial direction, are checked by means of the inspection device 6.

The inspection devices 4, 6 check the cut registration of the sheets 2, 82, 83, i.e. the position of at least one trimmed edge, preferably of all trimmed edges of the sheets 2, 82, 83 in relation to a reference marker, for example within a printed image. Preferably the entire sheets, including the entire printed image, are checked.

From the inspection device 6, the chain conveyor 47 conveys the partial sheets 82, 83, which have been trimmed on all sides and checked on front and back, to the six stacks 63, 64, 66 to 69 of the feeder 62. There, the partial sheets 82, 83 can be selectively deposited on one of the six stacks 63, 64, 66 to 69. In this connection, the first four stacks 63, 64, 66, 67 preferably receive so-called “good” sheets, and the two last stacks 67, 68, which are arranged next to each other, receive waste sheets.

In place of sheets 2, 82, 83, it is also possible, for example, to trim or cut printed webs, i.e. printed materials, and to subsequently check them by means of one or several inspection devices 3, 4, 6. In this case the cutting devices 1, 38, 57 can be arranged, for example, in the area of a folding mechanisms of a web-fed rotary printing press.

There, a web is cut, for example in the longitudinal direction, into several partial webs, and is subsequently cut into signatures in the transverse direction. In this case the cut registration can be checked after each step, or after the web has been cut completely into signatures.

The inspection devices 3, 4, 6 preferably contain one or several CCD area cameras, which check the sheet as a whole.

### List of Reference Numbers

1 Sheet processing machine

2 Sheet

3 Inspection device, first

4 Inspection device, second

5 Inspection

6 device, third

7 Feeder

8 Stack (7)

9 Sheet separating device (7)

10 -

11 Delivery table

12 Installation

13 Chain conveyor

14 Chain

15 -

16 Chain gripper system

17 Chain wheel shaft, first (16)

18 Chain wheel shaft, second (16)

19 Suction box (3)

20 -

21 Transverse cutting device

22 Cutting cylinder (21)

23 Cross bar

24 Opposed cutter (21)

25 -

26 Cutter (22)

27 Sensor (4)

28 Turning device

29 Storage drum (28)

30 -

31 Turning drum

32 Gripper system (29)

33 Suction system (29)

34 Gripper system, first (31)

35 Suction box (4)

36 Gripper system, second (31)

37 Processing cylinder

38 Longitudinal cutting device

39 Gripper system, (37)

40 Cam

41 Gripper system (37)

42 Gripper system (37)

43 Gripper system (37)

44 Cutter wheel (38)

45 Cam roller

46 Cross bar (38)

47 Chain conveyor

48 Chains (47)

49 Chain gripper system (47)

50 -

51 Chain wheel shaft, first (47)

52 Chain wheel shaft, second (47)

53 Median line (37, 51)

54 Median line (37, 44)

55 -

56 Suction box

57 Transverse cutting device

58 Sensor (6)

59 Illumination device (6)

60 -

61 Suction box (6)

62 Feeder

63 Stack, first (62)

64 Stack, second (62)

65 -

66 Stack, third (62)

67 Stack, fourth (62)

68 Stack, fifth (62)

69 Stack, sixth (62)

70 -

71 Front end (2)

72 End (2)

73 Strip

74 Cut, first

75 -

76 Cut,

77 second

78 Cut, third

79 Cut, fifth

80 Strip

81 Strip

82 Partial sheet (2)

83 Partial sheet (2)

84 Cut, fifth

85 -

86 Strip

T Transport direction

alpha Opening angle (53, 54)

1. A method for cutting sheets (2) in a sheet processing machine (1), characterized in that first a trailing end (72) of the sheet (2) is trimmed perpendicularly in relation to a transport direction (T) by means of a first transverse cutting device (21), that subsequently the sheet (2) is turned in the processing machine (1) so that the trimmed end (72) of the sheet (2) leads, and that the front (71) of the turned sheet (2), which now trails, is trimmed perpendicularly in relation to the transport direct (T) by means of a second transverse cutting device (57).

2. The method in accordance with claim 1, characterized in that the sheet (2) is divided by a longitudinal cut (78) into a plurality of partial sheets (82, 83), which lie next to each other.

3. The method in accordance with claim 1, characterized in that the longitudinal sides of the sheet (2), which extend parallel in relation to the transport direction (T), are trimmed.

4. The method in accordance with claim 1, characterized in that the longitudinal cuts (76, 77, 78) are performed between the first (74) and the second transverse cut (76).

5. The method in accordance with claims 1 and 2, characterized in that the sheet (2) is cut into partial sheets (82, 83) after having been turned.

6. The method in accordance with claim 1, characterized in that following the first transverse cutting of the sheet (2), it is checked by means of an inspection device (4).

7. The method in accordance with claim 1, characterized in that following the second transverse cutting of the sheet (2), it is checked by means of an inspection device (6).

8. The method in accordance with claims 1 to 3, characterized in that the sheet (2) or the partial sheets (82, 83) are checked by means of an inspection device (6) after all cuts (74, 76, 77, 78, 79) have been made.

9. The method in accordance with claim 1, characterized in that the sheet (2) is checked by means of an inspection device (3) prior to performing the first cut (74).

10. The method in accordance with claim 1, characterized in that the sheet (2) and/or the partial sheets (82, 83) are conveyed by means of gripper systems (16, 32, 34, 36, 39, 41, 42, 43, 49).

11. A sheet processing machine (1) with a first transverse cutting device (21), characterized in that, viewed in the transport direction (T) of the sheets (2), a turning device (28) is arranged downstream of the first transverse cutting device (21), and that a second transverse cutting device (57) is arranged downstream of the turning device (28).

12. The sheet processing machine (1) in accordance with claim 11, characterized in that an inspection device (4) is arranged between the first transverse cutting device (21) and the turning device (28).

13. The sheet processing machine (1) in accordance with claim 11, characterized in that an inspection device (6) is arranged downstream of the second transverse cutting device (57).

14. The sheet processing machine (1) in accordance with claim 11, characterized in that a longitudinal cutting device (38) is arranged downstream of the turning device (28).

15. The sheet processing machine (1) in accordance with claims 12 or 13, characterized in that the inspection device (4, 6) is arranged immediately downstream of the transverse cutting device (21, 57), and that the inspection device (4, 6) has a suction box (35, 61) for guiding sheets (2).

16. The sheet processing machine (1) in accordance with claim 11, characterized in that the transverse cutting devices (21, 57) are arranged to be working together with a chain conveyor (13, 47), which conveys the sheets (2).
